(19) United States
(12) Patent Application Publication
(10) Pub. No.: US 2025/0023192 A1
(43) Pub. Date: Jan. 16, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Jungyoon Lee, Yongin-si (KR); Soohee Kim, Yongin-si (KR); Changhong Ko, Yongin-si (KR); Sam-Jin Park, Yongin-si (KR); Jinweon Seo, Yongin-si (KR)

(21) Appl. No.: 18/418,739

(22) Filed: Jan. 22, 2024

(30) Foreign Application Priority Data
Jul. 12, 2023 (KR) 10-2023-0090559

(51) Int. Cl. H01M 50/443; H01M 4/62; H01M 10/052; H01M 50/434; H01M 50/449

(52) U.S. Cl. CPC H01M 50/443; H01M 4/622; H01M 10/052; H01M 50/434; H01M 50/449

(57) ABSTRACT

A separator for a rechargeable lithium battery and a rechargeable lithium battery including the same, the separator includes a substrate; and a coating layer on at least one surface of the substrate, wherein the coating layer includes cube-shaped inorganic particles having a D50 particle diameter of greater than or equal to about 0.15 μm and less than about 0.4 μm, and a D99 particle diameter of greater than or equal to about 0.4 μm and less than or equal to about 1.0 μm, and the coating layer has a thickness of greater than 0 μm and less than about 2.0 μm.

### CROSS-REFERENCE TO RELATED APPLICATION

This application claims priority to and the benefit of Korean Patent Application No. 10-2023-0090559 filed in the Korean Intellectual Property Office on Jul. 12, 2023, the entire contents of which are incorporated herein by reference.

### BACKGROUND

### 1. Field

Embodiments relate to a separator for a rechargeable lithium battery and a rechargeable lithium battery including the same.

### 2. Description of the Related Art

Recently, with the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery may include a positive electrode and a negative electrode including an active material capable of intercalating and deintercalating lithium ions, and an electrolyte, and electrical energy may be produced through oxidation and reduction reactions when lithium ions are intercalated/deintercalated from the positive electrode and negative electrode.

### SUMMARY

The embodiments may be realized by providing a separator for a rechargeable lithium battery, the separator includes a substrate; and a coating layer on at least one surface of the substrate, wherein the coating layer includes cube-shaped inorganic particles having a D50 particle diameter of greater than or equal to about 0.15 μm and less than about 0.4 μm, and a D99 particle diameter of greater than or equal to about 0.4 μm and less than or equal to about 1.0 μm, and the coating layer has a thickness of greater than 0 μm and less than about 2.0 μm.

The thickness of the coating layer may be greater than or equal to about 1.0 μm and less than or equal to about 1.5 μm.

The cube-shaped inorganic particles may have a D50 particle diameter of greater than or equal to about 0.15 μm and less than or equal to about 0.25 μm.

The cube-shaped inorganic particles may have a D99 particle diameter of greater than or equal to about 0.4 μm and less than or equal to about 0.6 μm.

A coating density of the coating layer may be greater than or equal to about 1.1 L/L.

The cube-shaped inorganic particles may include boehmite, silica (SiO₂), alumina (Al₂O₃), titania (TiO₂), clay, BaSO₄, MgO, Mg(OH)₂, or a combination thereof.

The coating layer may further include a binder.

The coating layer may include about 50 wt % to about 98 wt % of the inorganic particles, and about 2 wt % to about 50 wt % of the binder, all wt % being based on a total weight of the coating layer.

The binder may include a polyacrylamide binder.

The coating layer may be on two surfaces of the substrate.

When exposed to 150° C. for 1 hour, the separator may have a heat shrinkage rate in a machine direction of less than or equal to about 10%, and a heat shrinkage rate in a transverse direction of less than about 10%.

The embodiments may be realized by providing a rechargeable lithium battery including a positive electrode; a negative electrode; and the separator according to an embodiment between the positive electrode and the negative electrode.

### BRIEF DESCRIPTION OF THE DRAWINGS

Features will be apparent to those of skill in the art by describing in detail exemplary embodiments with reference to the attached drawings in which:

FIG. 1 is an exploded perspective view of a rechargeable lithium battery according to some embodiments.

FIG. 2 shows an SEM image of the separator of Example 2 viewed from the top of the coating layer.

FIG. 3 shows an SEM image of the separator of Comparative Example 1 viewed from the top of the coating layer.

FIG. 4 shows an SEM image of the separator of Comparative Example 2 viewed from the top of the coating layer.

FIG. 5 shows an SEM image of the separator of Comparative Example 3 viewed from the top of the coating layer.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, the singular may also include the plural. In addition, unless otherwise specified, “A or B” may mean “including A, including B, or including A and B.”

As used herein, “combination thereof” may mean a mixture of constituents, a stack, a composite, a copolymer, an alloy, a blend, and a reaction product.

As used herein, “D50 particle diameter” and “D99 particle diameter” is the particle size at 50% and the particle size at 99% by volume in a cumulative size-distribution curve, respectively.

The “D50 particle diameter” and “D99 particle diameter” can be measured by suitable methods, e.g., by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the “D50 particle diameter” and “D99 particle diameter” may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle diameter (D50) based on 50% of the particle size distribution and the average particle diameter (D99) based on 99% of the particle size distribution in the measuring device can be calculated. The measurement of the D50 and D99 particle diameters is independent of the particle shape. That is, the D50 and D99 particle diameters of spherical particles as well as non-spherical particles (e.g. the cube-shaped particles) can be measured according to the above measurement method.

In this specification, “weight average molecular weight” is a value measured by gel permeation chromatography (GPC, PL GPC220, Agilent Technologies) and corrected with a cubic function using polystyrene.

### (Separator)

Some embodiments provides a separator for a rechargeable lithium battery. The separator may include, e.g., a substrate and a coating layer on at least one surface of the substrate. In an implementation, the coating layer may include, e.g., cube-shaped inorganic particles having a D50 particle diameter of greater than or equal to about 0.15 μm and less than about 0.4 μm and a D99 particle diameter of greater than or equal to about 0.4 μm and less than or equal to about 1.0 μm. In an implementation, the coating layer may have a thickness of greater than about 0 μm and less than about 2 μm.

The separator according to some embodiments exhibits excellent heat resistance even at a thin thickness by controlling the shapes and particle diameters of the inorganic particles.

By applying a separator that exhibits excellent heat resistance even at a thin thickness as described above, it is possible to increase the energy density of a rechargeable lithium battery and improve its high-temperature characteristics.

Hereinafter, the separator of some embodiments will be described in more detail.

### Thickness of Coating Layer

If the thickness of the coating layer were to be about 2 μm or more, there could be a limit to increasing the energy density of the rechargeable lithium battery.

Accordingly, in some embodiments, in order to increase the energy density of the rechargeable lithium battery, the thickness of the coating layer may be, e.g., greater than 0 μm and less than about 2 μm. In an implementation, the thickness of the coating layer may be, e.g., greater than or equal to about 1 μm and less than or equal to about 1.5 μm.

Within the above ranges, e.g., the thinner the thickness of the coating layer is, the more advantageous it is to increase the energy density of the rechargeable lithium battery.

### Shape and D50 Particle Diameter and D99 Particle Diameter of Inorganic Particles

Even if the D50 particle diameter were to be the same and the D99 particle diameter were to be the same, the coating density of the coating layer may be improved when cube-shaped inorganic particles are applied, compared to plate-shaped inorganic particles.

Accordingly, the separator of some embodiments may use cube-shaped inorganic particles rather than plate-shaped inorganic particles.

In an implementation, the cube-shaped inorganic particles may be used, and the characteristics of the separator may vary depending on its D50 particle diameter and D99 particle diameter.

If the cube-shaped inorganic particles having a D50 particle diameter of greater than or equal to about 0.4 μm and a D99 particle diameter of greater than about 1.0 μm were to be used, thermal stability may be maintained only when the thickness of the coating layer is greater than or equal to about 2 μm.

In an implementation, the D50 particle diameter of the cube-shaped inorganic particles may be less than about 0.15 μm and the D99 particle diameter may be less than about 0.4 μm, the moisture content of the separator may increase, and side reactions and resistance in the rechargeable lithium battery may increase.

Accordingly, the separator of some embodiments may limit the D50 particle diameter of the cube-shaped inorganic particles to a range of greater than or equal to about 0.15 μm and less than about 0.4 μm and the D99 particle diameter to a range of greater than or equal to about 0.4 μm and less than or equal to about 1.0 μm. In the above ranges, the D50 particle diameter and D99 particle diameter of the cube-shaped inorganic particles may become smaller, and the coating density of the coating layer may be improved.

In an implementation, the D50 particle diameter of the cube-shaped inorganic particles may be greater than or equal to about 0.15 μm and less than or equal to about 0.25 μm and the D99 particle diameter of the cube-shaped inorganic particles may be greater than or equal to about 0.4 μm and less than or equal to about 0.6 μm.

In an implementation, cube-shaped inorganic particles may be used, rather than plate-shaped inorganic particles, thereby realizing a separator that has a high coating density even when the thickness of the coating layer is thin, and consequently exhibits excellent heat resistance.

### Coating Density of Coating Layer

In an implementation, the D50 particle diameter of the cube-shaped inorganic particles may be greater than or equal to about 0.15 μm and less than about 0.4 μm, the D99 particle diameter may be greater than or equal to about 0.4 μm and less than or equal to about 1.0 μm, and a coating density of the coating layer may be, e.g., greater than or equal to about 1.1 L/L. The coating density refers to the weight per unit area (Loading Level; L/L) of the coating layer, and is determined by measuring the thickness of the coating layer to determine the volume per unit area of the coating layer and reflecting the previously measured weight per unit volume.

In an implementation, the D50 particle diameter of the cube-shaped inorganic particles may be greater than or equal to about 0.15 μm and less than or equal to about 0.25 μm, the D99 particle diameter of the cube-shaped inorganic particles may be greater than or equal to about 0.4 μm and less than or equal to about 0.6 μm, and the coating density of the coating layer may be greater than or equal to about 1.35 L/L.

### Types of Inorganic Particles

The cube-shaped inorganic particles may be of a suitable type that are a heat resistant inorganic particle and has a cube-shaped shape.

In an implementation, the cube-shaped inorganic particles may include, e.g., boehmite, silica (SiO₂), alumina (Al₂O₃), titania (TiO₂), clay, BaSO₄, MgO, Mg(OH)₂, or a combination thereof. In an implementation, the cube-shaped inorganic particles may be boehmite, which makes it easy to control the shape, D50 particle diameter, and D99 particle diameter.

### Binder

The coating layer may further include a binder. In an implementation, the binder may include a polyacrylamide (PAM) binder. The weight average molecular weight of the binder measured by GPC method may be, e.g., about 10,000 g/mol to about 1,000,000 g/mol, or about 200,000 g/mol to about 400,000 g/mol.

The coating layer may include the inorganic particles in an amount of, e.g., about 50 wt % to about 98 wt %, about 80 wt % to about 98 wt %, about 90 wt % to about 98 wt %, or about 95 wt % to about 98 wt %; and the binder in an amount of about 2 wt % to about 50 wt %, about 2 wt % to about 20 wt %, about 2 wt % to about 10 wt %, or about 2 wt % to about 5 wt %, based on a total weight of the coating layer.

### Single-Surface Coating or Both-Surfaces Coating

In an implementation, the coating layer may be on only one surface of the substrate (single-surface coating). In an implementation, the coating layer may be on two, e.g., both surfaces (both-surface coating), and the heat resistance improvement effect of the rechargeable lithium battery may be improved.

### Substrate

The substrate may be a porous substrate.

The porous substrate may have plurality of pores and may be a substrate suitably used in electrochemical devices. The porous substrate may be, e.g., a polymer film formed of a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyetheretherketone, polyaryletherketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON (tetrafluoroethylene), or polytetrafluoroethylene.

In an implementation, the porous substrate may be a polyolefin substrate containing a polyolefin. In an implementation, the polyolefin substrate may have an excellent shutdown function, which may help contribute to improving the safety of the battery. The polyolefin substrate may include, e.g., a polyethylene single film, a polypropylene single film, a polyethylene/polypropylene double film, a polypropylene/polyethylene/polypropylene triple film, or a polyethylene/polypropylene/polyethylene triple film. In an implementation, the polyolefin resin may include a non-olefin resin in addition to an olefin resin, or may include a copolymer of olefin and non-olefin monomer.

In an implementation, the porous substrate may have a thickness of, e.g., about 1 μm to about 40 μm, about 1 μm to about 30 μm, about 1 μm to about 20 μm, about 5 μm to about 20 μm, about 5 μm to about 15 μm, or about 5 μm to about 10 μm.

### Heat Resistance of Separator

The separator of some embodiments may have a heat shrinkage rate in the machine direction (MD) of, e.g., less than or equal to about 10%, less than or equal to about 7%, less than or equal to about 6%, or less than or equal to about 3% when exposed to 150° C. for 1 hour; and a heat shrinkage rate in the transverse direction (TD) direction of, e.g., less than about 10%, less than or equal to about 9%, less than or equal to about 6%, or less than or equal to about 2%.

The above ranges may be due to controlling the shape and particle size of the inorganic particles, and may provide a separator that exhibits excellent heat resistance even at a thin thickness.

### Manufacturing Method

A separator for a rechargeable lithium battery according to some embodiments may be manufactured by various suitable methods. In an implementation, a separator for a rechargeable lithium battery may be formed by applying a composition for forming a coating layer to one or both surfaces of a porous substrate and then drying it.

The coating method may include, e.g., spin coating, dip coating, bar coating, die coating, slit coating, roll coating, inkjet printing, or the like.

The drying may be, e.g., performed through natural drying, drying with warm air, hot air, or low humid air, vacuum-drying, or radiation of a far-infrared ray, an electron beam, or the like. The drying process may be performed at a temperature of, e.g., about 25° C. to about 120° C.

The separator for a rechargeable lithium battery may be manufactured by lamination, coextrusion, or the like in addition to the above method.

### (Rechargeable Lithium Battery)

Some embodiments provide a rechargeable lithium battery including the aforementioned separator for a rechargeable lithium battery.

### Positive Electrode Active Material

The positive electrode active material may include a compound (lithiated intercalation compound) capable of intercalating and deintercalating lithium. In an implementation, one or more types of composite oxides of lithium and a metal, e.g., cobalt, manganese, nickel, or combinations thereof, may be used.

The composite oxide may include a lithium transition metal composite oxide, e.g., a lithium nickel oxide, lithium cobalt oxide, lithium manganese oxide, a lithium iron phosphate compound, cobalt-free lithium nickel-manganese oxide, or a combination thereof.

In an implementation, a compound represented by one of the following chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O₂₋ₐD′ₐ (0.90≤a≤1.8, 0≤b≤0.5, 0≤c≤0.5, 0<α<2); LiₐNi_{1-b-c}Mn_{b}X_{c}O₂₋ₐD′ₐ (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂ PO₄₃ (0≤f≤2); LiₐFePO₄ (0.90≤a≤1.8).

In the above chemical formulae, A may be, e.g., Ni, Co, Mn, or a combination thereof; X may be, e.g., Al, Ni, Co, Mn, Cr, Fe, Mg, Sr, V, a rare earth element, or a combination thereof; D′ may be, e.g., O, F, S, P, or a combination thereof; G may be, e.g., Al, Cr, Mn, Fe, Mg, La, Ce, Sr, V, or a combination thereof; and L¹ may be, e.g., Mn, Al, or a combination thereof.

In an implementation, the positive electrode active material may be a high nickel positive electrode active material having a nickel content of, e.g., greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of metals excluding lithium in the lithium transition metal composite oxide. The high-nickel positive electrode active materials may achieve high capacity and may be applied to high-capacity, high-density rechargeable lithium batteries.

### Positive Electrode

The positive electrode for a rechargeable lithium battery may include a current collector and a positive electrode active material layer on the current collector. The positive electrode active material layer may include a positive electrode active material and may further include a binder or a conductive material.

In an implementation, the positive electrode may further include an additive that may function as a sacrificial positive electrode.

A content of the positive electrode active material may be, e.g., about 90 wt % to about 99.5 wt %, and a content of the binder and the conductive material may be, e.g., about 0.5 wt % to about 5 wt %, respectively, based on 100 wt % of the positive electrode active material layer.

The binder may help attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material may help impart conductivity (e.g., electrical conductivity) to the electrode. A suitable material that does not cause chemical change (e.g., does not cause an undesirable chemical change in the rechargeable lithium battery) and conducts electrons may be used in the battery. Examples of the conductive material may include a carbon material such as natural graphite, artificial graphite, carbon black, acetylene black, ketjen black, a carbon fiber, a carbon nanofiber, and carbon nanotube; a metal material including copper, nickel, aluminum, silver, etc., in a form of a metal powder or a metal fiber; a conductive polymer such as a polyphenylene derivative; or a mixture thereof.

In an implementation, Al may be used as the current collector.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon negative electrode active material, e.g., crystalline carbon, amorphous carbon, or a combination thereof. The crystalline carbon may include graphite such as non-shaped, sheet-shaped, flake-shaped, sphere-shaped, or fiber-shaped natural graphite or artificial graphite. The amorphous carbon may include a soft carbon, a hard carbon, a mesophase pitch carbonization product, calcined coke, or the like.

The lithium metal alloy may include lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may include a Si negative electrode active material or a Sn negative electrode active material. The Si negative electrode active material may include silicon, a silicon-carbon composite, SiOₓ (0<x<2), a Si-Q alloy (wherein Q is selected from an alkali metal, an alkaline-earth metal, a Group 13 element, a Group 14 element (excluding Si), a Group 15 element, a Group 16 element, a transition metal, a rare earth element, and a combination thereof). The Sn negative electrode active material may include Sn, SnO₂, a Sn-based alloy, or a combination thereof.

The silicon-carbon composite may include a composite of silicon and amorphous carbon. In an implementation, the silicon-carbon composite may be in the form of silicon particles and amorphous carbon coated on the surface of the silicon particles. In an implementation, the silicon-carbon composite may include a secondary particle (core) in which primary silicon particles are assembled, and an amorphous carbon coating layer (shell) on the surface of the secondary particle. The amorphous carbon may also be between the primary silicon particles, and, e.g., the primary silicon particles may be coated with the amorphous carbon. The secondary particle may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on a surface of the core.

The Si negative electrode active material or the Sn negative electrode active material may be used in combination with a carbon negative electrode active material.

### Negative Electrode

A negative electrode for a rechargeable lithium battery may include a current collector and a negative electrode active material layer on the current collector. The negative electrode active material layer may include a negative electrode active material and may further include a binder or a conductive material.

In an implementation, the negative electrode active material layer may include, e.g., about 90 wt % to about 99 wt % of the negative electrode active material, about 0.5 wt % to about 5 wt % of the binder, and about 0.5 wt % to about 5 wt % of the conductive material.

The binder may help attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

In an implementation, an aqueous binder may be used as the negative electrode binder, and it may further include a cellulose compound capable of imparting viscosity (e.g., a thickener). The cellulose compound may include, e.g., carboxylmethyl cellulose, hydroxypropylmethyl cellulose, methyl cellulose, or alkali metal salts thereof. The alkali metal may include, e.g., Na, K, or Li.

The dry binder may be a polymer material capable of being fiberized, and may include, e.g., polytetrafluoroethylene, polyvinylidene fluoride, polyvinylidene fluoride-hexafluoropropylene copolymer, polyethylene oxide, or a combination thereof.

The conductive material may help provide electrode conductivity, and a suitable electrically conductive material may be used as a conductive material unless it causes a chemical change. Examples of the conductive material may include a carbon material such as natural graphite, artificial graphite, carbon black, acetylene black, ketjen black, a carbon fiber, a carbon nanofiber, a carbon nanotube, and the like; a metal material such as copper, nickel, aluminum silver, and the like in the form of a metal powder or a metal fiber; a conductive polymer such as a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

### Electrolyte Solution

The electrolyte solution for a rechargeable lithium battery may include a non-aqueous organic solvent and a lithium salt.

The non-aqueous organic solvent may be a medium for transmitting ions taking part in the electrochemical reaction of a battery.

The non-aqueous organic solvent may include, e.g., a carbonate solvent, ester solvent, ether solvent, ketone solvent, alcohol solvent, aprotic solvent, or a combination thereof.

The carbonate solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include, e.g., methyl acetate, ethyl acetate, n-propyl acetate, dimethylacetate, methylpropionate, ethylpropionate, decanolide, mevalonolactone, valerolactone (valerolactone), caprolactone, or the like. The ether solvent may include, e.g., dibutyl ether, tetraglyme, diglyme, dimethoxyethane, 2-methyltetrahydrofuran, 2,5-dimethyltetrahydrofuran, or tetrahydrofuran. The ketone solvent may include, e.g., cyclohexanone. The alcohol solvent may include, e.g., ethyl alcohol, isopropyl alcohol, or the like. The aprotic solvent may include, e.g., nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, or the like.

The non-aqueous organic solvent may be used alone or in combination of two or more.

In an implementation, a carbonate solvent may be used, and cyclic carbonate and chain carbonate may be mixed and used, and cyclic carbonate and chain carbonate may be mixed at a volume ratio of about 1:1 to about 1:9.

The lithium salt dissolved in the organic solvent may supply lithium ions in a battery, may facilitate a basic operation of a rechargeable lithium battery, and may help improve transportation of the lithium ions between positive and negative electrodes. Examples of the lithium salt may include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato) borate (LiBOB).

### Rechargeable Lithium Battery

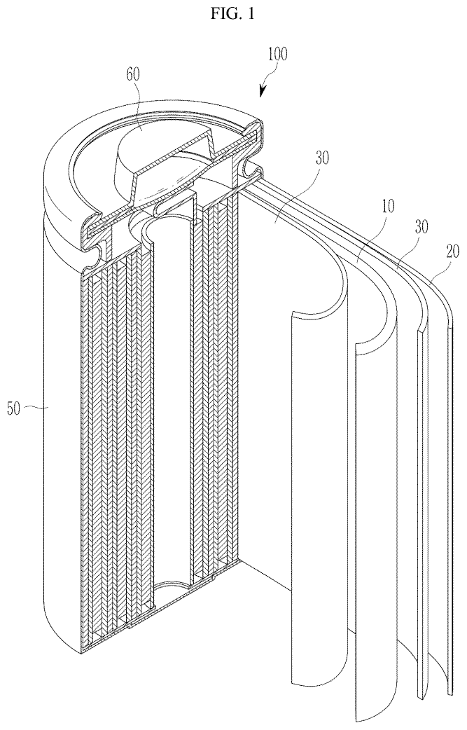

The rechargeable lithium battery may be a cylindrical battery, prismatic battery, pouch battery, coin-type battery, or the like depending on their shape. FIG. 1 is schematic view illustrating a rechargeable lithium battery according to some embodiments, and shows a cylindrical battery.

Referring to FIG. 1, the rechargeable lithium battery 100 may include an electrode assembly including a separator 30 between a positive electrode 10 and a negative electrode 20, and a case 50 in which the electrode assembly is housed. The positive electrode 10, the negative electrode 20, and the separator 30 may be impregnated with an electrolyte. The rechargeable lithium battery 100 may include a sealing member 60 that seals the case 50 as shown in FIG. 1.

The rechargeable lithium battery according to some embodiments may be applied to, e.g., automobiles, mobile phones, or various types of electrical devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES AND COMPARATIVE EXAMPLES

### Example 1

### (1) Preparation of Coating Layer Composition

As cube-shaped inorganic particles, boehmite having a D50 particle diameter of 0.2 μm and a D99 particle diameter of 0.4 to 0.6 μm (Product name: KC-02R, Manufacturer: KC) was used. In addition, as a binder, polyacrylamide (PAM) having a weight average molecular weight of 300,000 g/mol, which was measured in a GPC method, was used. Furthermore, DI water was used as a solvent.

95 parts by weight of the cube-shaped inorganic particles and 5 parts by weight of the binder were dispersed by mixing in 150 parts by weight of the solvent at 25° C. for 30 minutes by using a mechanical stirring device to prepare a coating layer composition having a solid content of 40 wt %.

### (2) Manufacturing of Separator

The coating layer composition was bar-coated to be 1 μm thick respectively on both surfaces of a 12 μm-thick polyethylene porous substrate (air permeability: 120 sec/100 cc, puncture strength: 450 kgf, SK Inc.) and then, dried at 70° C. for 10 minutes to manufacture a separator.

### (3) Manufacture of Rechargeable Lithium Battery Cells

LiCoO₂ as a positive electrode active material, polyvinylidene fluoride as a binder, and carbon as a conductive material were mixed in a weight ratio of 92:4:4 and then, dispersed in N-methyl-2-pyrrolidone to prepare positive electrode slurry. The slurry was coated on a 20 μm-thick Al foil, dried, and compressed to manufacture a positive electrode.

Artificial graphite as a negative electrode active material, a styrene-butadiene rubber as a binder and carboxylmethyl cellulose as a thickener in a weight ratio of 96:2:2 were dispersed in distilled water to prepare negative electrode active material slurry. The slurry was coated on a 15 μm-thick, dried, and compressed to manufacture a negative electrode.

A cylindrical battery cell was manufactured using the positive electrode, negative electrode, and separator. The electrolyte solution was a 1.3 M LiPF₆ solution in a mixed solvent of ethyl carbonate (EC)/ethylmethyl carbonate (EMC)/diethyl carbonate (DEC) (volume ratio of 3/5/2).

### Example 2

A coating layer composition, a separator, and a rechargeable lithium battery cell were manufactured in the same manner as in Example 1 except that boehmite having a D50 particle diameter of 0.25 μm and a D99 particle diameter of 0.4 μm to 0.6 μm (Product name: KC-025R, Manufacturer: KC) was used as the cube-shaped inorganic particles.

### Example 3

A coating layer composition, a separator, and a rechargeable lithium battery cell were manufactured in the same manner as in Example 1 except that boehmite having a D50 particle diameter of 0.3 μm and a D99 particle diameter of 0.4 μm to 0.6 μm (Product name: KC-03R, Manufacturer: KC) was used as the cube-shaped inorganic particles.

### Example 4

A coating layer composition, a separator, and a rechargeable lithium battery cell were manufactured in the same manner as in Example 1 except that boehmite having a D50 particle diameter of 0.25 μm and a D99 particle diameter of 0.6 μm or more to 1.0 μm or less (Product name: KC-035R, Manufacturer: KC) was used as the cube-shaped inorganic particles.

### Example 5

A coating layer composition, a separator, and a rechargeable lithium battery cell were manufactured in the same manner as in Example 1 except that 98 parts by weight of the cube-shaped inorganic particles, 2 parts by weight of the binder, and 150 parts by weight of the solvent were mixed at 25° C. for 30 minutes.

### Example 6

A separator and a rechargeable lithium battery cell were manufactured in the same manner as in Example 1 except that the coating layer composition was coated to be 1.5 μm thick respectively on both surfaces of the polyethylene porous substrate.

### Comparative Example 1

A separator and a rechargeable lithium battery cell were manufactured in the same manner as in Example 1 except that a separator having no coating was used.

### Comparative Example 2

A coating layer composition, a separator, and a rechargeable lithium battery cell were manufactured in the same manner as in Example 1 except that boehmite having a D50 particle diameter of 0.4 μm and a D99 particle diameter of 0.9 μm (Product name: KC-04S, Manufacturer: KC) was used as sheet-shaped inorganic particles; and the prepared coating layer composition was coated to be 2 μm thick respectively on both surfaces of the polyethylene porous substrate.

### Comparative Example 3

A coating layer composition, a separator, and a rechargeable lithium battery cell were manufactured in the same manner as in Example 1 except that boehmite having a D50 particle diameter of 0.25 μm and a D99 particle diameter of 0.8 μm (Product name: KC-025S, Manufacturer: KC) was used as sheet-shaped inorganic particles.

### Comparative Example 4

A coating layer composition, a separator, and a rechargeable lithium battery cell were manufactured in the same manner as in Example 1 except that boehmite having a D50 particle diameter of 0.4 μm and a D99 particle diameter of 0.5 μm (Product name: KC-04R, Manufacturer: KC) was used as cube-shaped inorganic particles; and the prepared coating layer composition was coated to be 2 μm thick respectively on both surfaces of the polyethylene porous substrate.

Each of the separators according to the examples and the comparative examples are shown in Table 1.

TABLE 1

| | | | | Coating | Thick- |
|---|---|---|---|---|---|
| | | | | layer | ness |
| | Inorganic particles | | | Inorganic | (perone |
| | D50 | | | particles: | surface, |
| | (μm) | D99 (μm) | Shape | binder | μm) |
| Example 1 | 0.2 | 0.4 to 0.6 | cube-shaped | 95:5 | 1 |
| Example 2 | 0.25 | 0.4 to 0.6 | cube-shaped | 95:5 | 1 |
| Example 3 | 0.3 | 0.4 to 0.6 | cube-shaped | 95:5 | 1 |
| Example 4 | 0.25 | 0.6 or more to | cube-shaped | 95:5 | 1 |
| | | 1.0 or less | | | |
| Example 5 | 0.25 | 0.4 to 0.6 | cube-shaped | 98:2 | 1 |
| Example 6 | 0.25 | 0.4 to 0.6 | cube-shaped | 95:5 | 1.5 |
| Comparative | — | — | — | — | — |
| Example 1 | | | | | |
| Comparative | 0.4 | 0.9 | sheet-shaped | 95:5 | 2 |
| Example 2 | | | | | |
| Comparative | 0.25 | 0.8 | sheet-shaped | 95:5 | 1 |
| Example 3 | | | | | |
| Comparative | 0.4 | 0.5 | cube-shaped | 95:5 | 2 |
| Example 4 | | | | | |

### EVALUATION EXAMPLES

### Evaluation Example 1: Separator

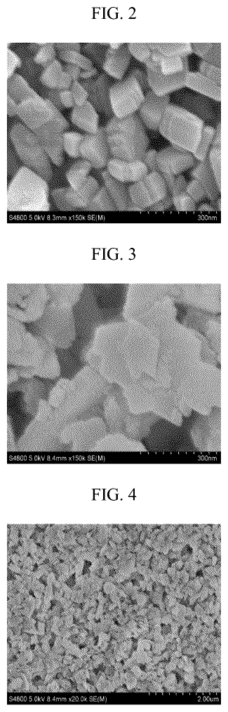

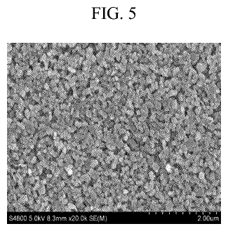

(1) SEM: Representatively, an SEM image of each of the separators according to Example 2 and Comparative Examples 1 to 3 was taken from the top of the coating layer, and then, the SEM images are shown respectively in FIGS. 2 to 5.

(2) Coating Density: After cutting each of the separators according to Examples 1 to 6 and Comparative Examples 1 to 4 into 10 cm (width)*10 cm (length) with the coating layer formed only on the cross-section of the polyethylene porous substrate during the process of manufacturing each separator, a weight (loading amount) of the coating layer alone was obtained by subtracting a weight of the coating layer from a total weight of the cross-section. The measured loading amount is divided by a coating thickness to obtain coating density, and the results are shown in Table 2.

(3) Heat Shrinkage Rate: Each of the separators according to Examples 1 to 6 and Comparative Examples 1 to 4 was cut into 10 cm×10 cm to prepare a sample. After drawing a quadrangle with a size of 5 cm×5 cm on the surface of the sample, the sample was inserted between papers or alumina powder, allowed to stand at 150° C. for 1 hour in an oven, and taken out therefrom to measure the size of the quadrangle, which was used to calculate each shrinkage rate in a machine direction (MD) and a transverse direction (TD).

$$\\ \begin{matrix}Heat shrinkage rate in MD direction = ( length in MD direction after high ‐ temperature shrinkage evaluation / length in MD direction of separator before evaluation ) \times 100 & [ Equation 1 ]\end{matrix}$$

$$\\ \begin{matrix}Heat shrinkage rate in TD direction = ( TD direction length after high ‐ temperature shrinkage evaluation / TD direction length of separator before evaluation ) \times 100 & [ Equation 2 ]\end{matrix}$$

TABLE 2

| | Coating | Heat shrinkage rate | |
|---|---|---|---|
| | density | (150° C., 1 hr (%)) | |
| | (L/L) | MD | TD |
| Example 1 | 1.41 | 2 | 2 |
| Example 2 | 1.35 | 3 | 2 |
| Example 3 | 1.29 | 7 | 6 |
| Example 4 | 1.1 | 10 | 9 |
| Example 5 | 1.37 | 6 | 6 |
| Example 6 | 1.4 | 2 | 2 |
| Comparative Example 1 | — | — | — |
| Comparative Example 2 | 1.32 | 3 | 3 |
| Comparative Example 3 | 1.13 | 10 | 10 |
| Comparative Example 4 | 1.33 | 4 | 3 |

### Evaluation Example 2: Rechargeable Lithium Battery Cells

### (1) Ambient-temperature Cycle-life Characteristics

Each rechargeable lithium battery cell of Examples 1 to 6 and Comparative Examples 1 to 4 was evaluated with respect to ambient-temperature cycle-life characteristics in the following method, and the results are shown in Table 3.

The rechargeable lithium battery cells were constant current-charged to 4.25 V at a current rate of 1.0 C and constant voltage-charged to a current of 0.05 C, while maintaining 4.25 V, and then, discharged to a voltage of 2.8 V at a constant current of 1.0 C in a chamber at ambient temperature (25° C.).

The charges and discharge as one cycle were repeated 500 times to evaluate capacity retention according to Equation 3.

### (2) High-Temperature Cycle-Life Characteristics

The rechargeable lithium battery cells of Examples 1 to 6 and Comparative Examples 1 to 4 were evaluated with respect to high-temperature cycle-life characteristics in the following method, and the results are shown in Table 3.

In a chamber at high temperature (45° C.), the rechargeable lithium battery cells were constant current-charged at a current rate of 1.0 C to 4.25 V and constant voltage-charged to 0.05 C, while maintaining 4.25 V, and then, discharged to 2.8 V at a constant current of 1.0 C.

This charges and discharge as one 1 cycle were repeated 500 times to evaluate capacity retention according to Equation 3.

$$\\ \begin{matrix}Capacity retention rate ( \% ) = ( discharge capacity at 500 th cycle / discharge capacity at first cycle ) \times 100 & [ Equation 3 ]\end{matrix}$$

### (3) Energy Density (E/D)

As for the rechargeable lithium battery cells according to Examples 1 to 6 and Comparative Examples 1 to 4, energy density according to a separator thickness was shown as a percentage (%).

TABLE 3

| | Ambient- | High-temperature | |
|---|---|---|---|
| | temperature | cycle- | |
| | cycle-life (%) | life (%) | E/D (%) |
| Example 1 | 92 | 81 | 100 |
| Example 2 | 96 | 83 | 100 |
| Example 3 | 94 | 80 | 100 |
| Example 4 | 95 | 79 | 100 |
| Example 5 | 96 | 83 | 100 |
| Example 6 | 95 | 82 | 75 |
| Comparative Example 1 | — | — | — |
| Comparative Example 2 | 96 | 82 | 50 |
| Comparative Example 3 | 96 | 82 | 100 |
| Comparative Example 4 | 95 | 82 | 50 |

The separators of the Examples exhibited excellent heat resistance even at a thin thickness by controlling a shape and a particle diameter of the inorganic particles.

The separators exhibiting excellent heat resistance, even at a thin thickness as described were applied, and energy density of the rechargeable lithium battery cells was not only increased, but also high-temperature characteristics thereof were improved.

By way of summation and review, in order to help reduce or prevent a short-circuit between the positive and negative electrodes in rechargeable lithium batteries, olefin substrates may be used as separators. The olefin substrate may have excellent flexibility, and may have rapid heat shrinkage at high temperatures of 100° C. or higher.

In order to address issues of the olefin substrate, a method of forming an inorganic particle coating layer on at least one surface of the olefin substrate has been considered. In a separator in which inorganic particles are coated on at least one surface of the olefin substrate, the thickness and heat resistance of the coating layer may vary depending on the shape and particle size of the inorganic particles, and further, the energy density and high-temperature characteristics of the rechargeable lithium battery may vary.

One or more embodiments may provide a separator that exhibits excellent heat resistance even at a thin thickness.

The separator according to some embodiments may exhibit excellent heat resistance even at a thin thickness by controlling the shape and particle diameter of the inorganic particles.

By applying a separator that exhibits excellent heat resistance even at a thin thickness as described above, it is possible to increase the energy density of a rechargeable lithium battery and improve its high-temperature characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator for a rechargeable lithium battery, the separator comprising:
a substrate; and
a coating layer on at least one surface of the substrate,
wherein:
the coating layer includes cube-shaped inorganic particles having:
a D50 particle diameter of greater than or equal to about 0.15 μm and less than about 0.4 μm, and
a D99 particle diameter of greater than or equal to about 0.4 μm and less than or equal to about 1.0 μm, and
the coating layer has a thickness of greater than 0 μm and less than about 2.0 μm.

2. The separator as claimed in claim 1, wherein the thickness of the coating layer is greater than or equal to about 1.0 μm and less than or equal to about 1.5 μm.

3. The separator as claimed in claim 1, wherein the cube-shaped inorganic particles have a D50 particle diameter of greater than or equal to about 0.15 μm and less than or equal to about 0.25 μm.

4. The separator as claimed in claim 1, wherein the cube-shaped inorganic particles have a D99 particle diameter of greater than or equal to about 0.4 μm and less than or equal to about 0.6 μm.

5. The separator as claimed in claim 1, wherein a coating density of the coating layer is greater than or equal to about 1.1 L/L.

6. The separator as claimed in claim 1, wherein the cube-shaped inorganic particles include boehmite, silica (SiO₂), alumina (Al₂O₃), titania (TiO₂), clay, BaSO₄, MgO, Mg(OH)₂, or a combination thereof.

7. The separator as claimed in claim 1, wherein the coating layer further includes a binder.

8. The separator as claimed in claim 7, wherein the coating layer includes:
about 50 wt % to about 98 wt % of the inorganic particles, and
about 2 wt % to about 50 wt % of the binder, all wt % being based on a total weight of the coating layer.

9. The separator as claimed in claim 7, wherein the binder includes a polyacrylamide binder.

10. The separator as claimed in claim 1, wherein the coating layer is on two surfaces of the substrate.

11. The separator as claimed in claim 1, wherein, when exposed to 150° C. for 1 hour, the separator has:
a heat shrinkage rate in a machine direction of less than or equal to about 10%, and
a heat shrinkage rate in a transverse direction of less than about 10%.

12. A rechargeable lithium battery, comprising:
a positive electrode;
a negative electrode; and
the separator as claimed in claim 1 between the positive electrode and the negative electrode.
